(19) United States
(12) Patent Application Publication
(10) Pub. No.: US 2007/0153239 A1
(43) Pub. Date: Jul. 5, 2007

(54) Light-beam generator and projecting system having the light-beam generator

(75) Inventors: Shuang-Chao Chung, Hsinchu Hsien (TW); Chun-Chuan Lin, Hsinchu Hsien (TW); Tian-Yuan Chen, Hsinchu Hsien (TW); Chi-Xiang Tseng, Hsinchu Hsien (TW); Hsin-Hsiang Lo, Hsinchu Hsien (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/450,405

(22) Filed: Jun. 12, 2006

(30) Foreign Application Priority Data
Dec. 30, 2005 (TW) 094147461

(51) Int. Cl. G03B 21/28

(52) U.S. Cl. 353/98

(57) ABSTRACT

A light-beam generator and a projecting system having the light-beam generator are proposed in the present invention. The light-beam generator includes an optical element and a light-emitting diode, wherein the optical element further includes a non-spherical reflecting curved surface which at least has a focus. Also, the light-emitting diode is located at the focus of the optical element for emitting light to the reflecting curved surface to form a light beam which is guided in a specific direction. By such arrangement, an output efficiency of light beams can be improved and a heat dissipation requirement can be reduced. Additionally, the light-beam generator proposed in the present invention can be applied to a projecting system having illuminant with specific polarized directions, so as to eliminate various prior-art drawbacks.

### FIELD OF THE INVENTION

The present invention relates to optical techniques, and more particularly, to a light-beam generator and a projecting system having the light-beam generator.

### BACKGROUND OF THE INVENTION

In recent years, along with the blooming development of the information technology and the photoelectron technology, the application of information has become more and more diversified. The application of the projecting systems has been used broadly in different occasions, for example, a powerpoint projector used in a conference, an image projector used in a meeting place, or even an image projector for playing movies at home. One of the most important factors in designing the projecting system is the intensity of an illuminant device. Generally speaking, the illuminant device with a stronger intensity can produce higher illumination, so as to produce a better projecting effect.

FIG. 1 is a schematic diagram showing a projecting system 1 of the prior art. The projecting system 1 comprises an illuminant device 11, a color wheel 13, a light pipe 15 and an imaging device 17. A light beam is produced by the illuminant device 11, and subsequently projected into the light pipe 15 after being light-filtered by the color wheel 13. The color wheel 13 which uses an axle 131 as an axis of rotation is assembled between the illuminant device 11 and the light pipe 15 to successively polarize the light beam using different polaroids. Then, three kinds of monochromatic light which are blue light, red light and green light are outputted, for modulation by the imaging device 17. The received monochromatic light is uniformized and increased in efficiency by the light pipe 15 before being projected onto the imaging device 17. The imaging device 17 serves to process the light beam outputted by the light pipe 15, and adjusted a picture of an image into the light beam to form an image light beam. Afterwards, the image light beam is projected to form an image onto a projection-screen 19.

The illuminant device 11 of the foregoing projecting system 1 comprises a bulb 111 and a bulb shade 113. The bulb 111 serves to produce light and the bulb shade 113 serves to converge the light produced from the bulb 111 into a light beam, such that the light demanded by the projecting system 1 can be provided. Referring to such design, if the brightness of the image projected by the projecting system 1 is to be improved, the luminescent power of bulb 111 needs to be increased. However, an increase in the luminescent power of the bulb 111 can result an increase in working temperature, which not only affects the service life of an imaging element (light valve) in the imaging device 17 but also results a burnout of bulb 111, so that the working efficiency and the service life of the projecting system 1 can be reduced as a consequence. Accordingly, the Taiwan Patent No. 594372 has disclosed a heat dissipating device to solve the foregoing problem. However, this design increases the dimension of the illuminant device, which results a drawback of bulkiness of the dimension of the projecting system, such that the dimension of the projecting system is difficult to be minified.

In order to improve the projecting effect of the forgoing projecting system 1 and increase the illuminant intensity, the Taiwan Patent No. 587195 has disclosed an illuminant device in a projector to generate a convergent light beam. The illuminant device comprises a plurality of light-beam generators for generating light beams, and a prism body for deflecting the light beams generated by the plurality of light-beam generators, such that the light beams generated by the light-beam generator are converged to form the convergent light beam. As the forgoing patent utilizes the plurality of light-beam generators and the prism body and each of the light-beam generators further comprises a light bulb and a collimator, the dimension of the illuminant device is enlarged, such that the dimension of the projecting system is also enlarged and miniaturization becomes difficult. Therefore, the projector utilizing such illuminant device also has a large dimension that cannot be minified easily.

In order to overcome the problems of the forgoing prior-art projecting system such as the excessively large dimension and the miniaturization problem and eliminate the drawback that the illuminant intensity cannot be easily improved, a light-emitting diode (LED) can be used with a collimator to produce light beams. Also, liquid crystal type display elements (such as LCD, LCOS) can be used to produce images. The U.S. Patent No. 2003/0133080, No. 2005/0219475 and No. 2005/0190307 have all disclosed related techniques. As the light-emitting diode (LED) is characterized with high color qualities and a low requirement of electric energy, the projecting system comprised by the light-emitting diode (LED) can be miniaturized.

As the liquid crystal type display element can only accept illuminants with specific polarized directions. Also, the light-emitting diode (LED) is unlike the light bulb that illuminates in all directions. Instead, it is characterized with semi-spherical luminescence. Therefore, in order to improve the output efficacy and the efficiency of the light-beam generator, the design and the corresponding location of the collimator that provides a light collecting effect has become particularly important.

As shown in FIG. 2, a light-beam generator 2 disclosed by the U.S. Patent No. 2005/0190307 comprises a light-emitting diode (LED) 21 and an optical element 23 having a reflecting surface 231. Actually, the optical element 23 having the reflecting surface 231 is a collimator. The reflecting surface 231 of the optical element 23 is designed as a curved surface, and the light-emitting diode (LED) 21 is located on a pathway of a light beam reflected and outputted by the reflecting surface 231 of the optical element 23. In other words, the illuminant from the light-emitting diode (LED) 21 will again interlace with the light-emitting diode (LED) 21 after being reflect-coupled by the reflecting surface of the optical element 23. Thus, a portion of the coupled light beams will be covered by the light-emitting diode (LED) 21, which will result in a remarkable loss in light efficiency. Furthermore, the optical element 23 has an excessively large dimension.

Referring to the light-beam generator 2 disclosed by the foregoing U.S. patent, poor output efficiency is resulted due to a remarkable loss in light efficiency of the outputted light beam. Also, as the light-emitting diode (LED) 21 comprises a circuit and is designed with heat dissipation, the design of the illuminant which interlaces with the light-emitting diode (LED) 21 again after being coupled will definitely result in the burden of heat dissipation of the light-emitting diode (LED) 21, such that miniaturization of the applicable projecting system can become difficult. Moreover, due to the poor output efficiency of the light-beam generator 2, the liquid crystal type display element which can only accept illuminant with specific polarized directions will have difficulty to provide sufficient illuminant intensity. Therefore, insufficient brightness of the projected image will be resulted, so that such kind of light-beam generator cannot be utilized in the projecting system having illuminant with specific polarized directions.

What is needed, therefore, is to provide a light-beam generator and a projecting system having the light-beam generator to effectively solve the problems caused by the prior-art technique.

### SUMMARY OF THE INVENTION

In light of the above prior-art drawbacks, a primary objective of the present invention is to provide a light-beam generator and a projecting system having the light-beam generator, by which an output efficiency of light beams can be improved.

Another objective of the present invention is to provide a light-beam generator and a projecting system having the light-beam generator, by which an output efficiency of light beams can be improved and a heat dissipation requirement can be reduced in a projecting system having illuminant with specific polarized directions.

A further objective of the present invention is to provide a light-beam generator and a projecting system having the light-beam generator, by which a heat dissipation requirement can be reduced.

In accordance with the foregoing and other objectives, the present invention proposes a light-beam generator, comprising an optical element having a non-spherical reflecting curved surface, wherein the reflecting curved surface at least comprises a focus; and a light-emitting diode located at the focus of the optical element for emitting light to the reflecting curved surface to form a light beam which is guided in a specific direction.

The light-emitting diode can be a light-emitting diode which emits light selected from the group consisting of red light, blue light, green light and white light. In a preferred embodiment, the light-emitting diode is a bare chip. In another preferred embodiment, the light-emitting diode is a package.

The present invention also proposes a projecting system, comprising a light-beam generator further comprising an optical element and a light-emitting diode, wherein the optical element has a non-spherical reflecting curved surface which at least comprises a focus, and the light-emitting diode is located at the focus of the optical element for emitting light to the reflecting curved surface to form a light beam which is guided to a specific direction; a collimating illumination device for receiving light beams from the light-beam generator and subsequently uniformizing the light beam and increasing efficiency of the light beam; and an imaging device for receiving the light beam from the collimating illumination device and adjusting an image picture into the light beam to form a image light beam for projection.

The foregoing projecting system comprises a plurality of symmetric light-beam generators arranged in arrays. The collimating illumination device can be selected from an array-arranged lens or an optical tunnel. The imaging device can comprise a displaying element and a projecting lens, wherein the displaying element can be selected from the group consisting of a liquid crystal display (LCD), a liquid crystal on silicon (LCOS) and a digital micromirror device (DMD). Furthermore, the light-emitting diode of each of the light-beam generators can be a combination of at least two light-emitting diodes selected from the group consisting of red light, blue light, green light and white light.

Referring to the foregoing light-beam generator and the projecting system proposed in the present invention, the reflecting curved surface can be a parabolic curved surface with a high reflection rate, or alternatively, an oval curved surface with a high reflection rate. Also, the reflecting curved surface is consisted of a metal coating formed on a surface of the optical element or a dielectric coating formed on a surface of the optical element. The reflecting curved surface has the following curve equation:

$$z = \frac{{cy}^{2}}{1 + \sqrt{1 - ( 1 + k ) {c}^{2} {y}^{2}}} + {α}_{1} {y}^{2} + {α}_{2} {y}^{4} + {α}_{3} {y}^{6} + {α}_{4} {y}^{8} + {α}_{5} {y}^{10} + {α}_{6} {y}^{12} + {α}_{7} {y}^{14} ,$$

wherein k is a conic constant, c is a curvature, and α₁ to α₇ are seven non-spherical constants.

Referring to the light-beam generator and the projecting system having the light-beam generator proposed in the present invention, the specific allocation relationship between the light-emitting diode of the light-beam generator and the optical element and the design of the reflecting curved surface of the optical element are able to prevent the light beams generated by the light-emitting diode from being again interlaced after being reflect-coupled by the optical element. Thus, the light beam is not shielded by the light-emitting diode after being reflect-coupled, such that a loss in an output efficiency of light beams can be avoided to improve the output efficiency of light beams and reduce a heat dissipation requirement. Therefore, the dimension of the light-beam generator can be reduced and the projecting system can also be miniaturized. As the light beam generated by the light-beam generator proposed in the present invention is not shielded and the loss in the output efficiency of light beams can be avoided, the best output efficiency of light beams can be achieved. By such arrangement, the light beam can be guided in a specific direction and thus the present invention can be applied to a projecting system having illuminant with specific polarized directions, so as to meet the requirement for the liquid displaying element (such as a liquid crystal display, a liquid crystal on silicon and a digital micromirror device).

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing a prior-art projecting system;

FIG. 2 is a schematic diagram showing a light-beam generator according to the U.S. Patent No. 2005/0190307;

FIG. 3A is a schematic diagram showing a light-beam generator according to the present invention;

FIG. 3B is a schematic diagram showing light emission of a light-beam generator according to the present invention;

FIG. 4 is a schematic diagram showing a projecting system according to the present invention; and

FIG. 5 is a schematic diagram showing an arrangement of a plurality of light-beam generators in a projecting system according to the present invention.

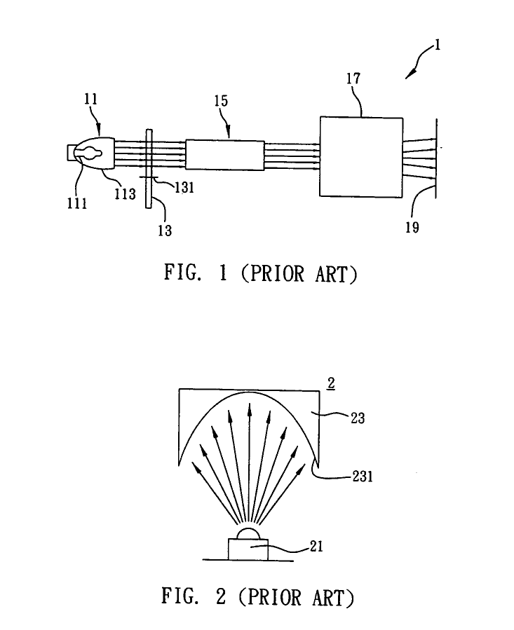

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

What needs to be concerned is that these drawings are simplified schematic diagrams, and thus only constructs relevant to the present invention are illustrated. Also, these constructs are not drawn according to actual amounts, shapes and dimensions. Actually, the amount, shape and dimension are an optional design and the arrangements of the constructs may be very complex in the reality.

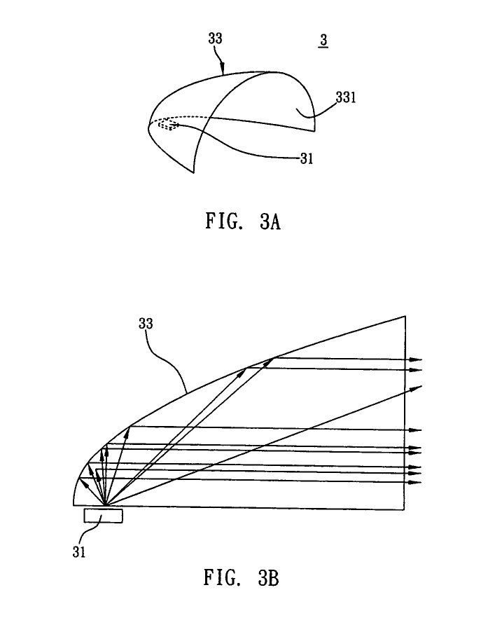

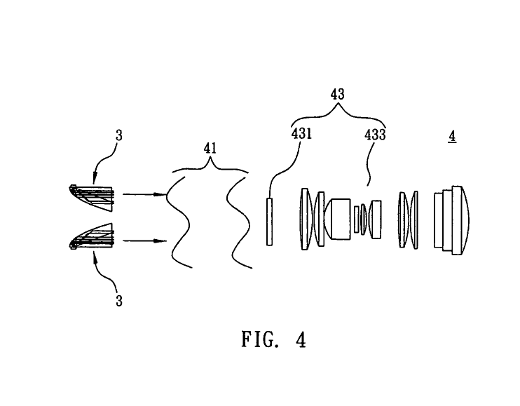

FIG. 3A and FIG. 3B are respectively a schematic diagram showing a light-beam generator 3 and a schematic diagram showing light emission of the light-beam generator 3 according to the present invention. The light-beam generator 3 comprises a light-emitting diode (LED) 31 and an optical element 33. The light-emitting diode 31 is a light-emitting diode which emits light selected from the group consisting of red light, blue light, green light and white light. In the present embodiment, the light-emitting diode 31 is in the form of a package. However, in another embodiment, the light-emitting diode 31 can be in the form of a bare chip. The optical element 33 is made of a material high in light transmittance such as plastic or glass.

The optical element 33 comprises a non-spherical reflecting curved surface 331. The reflecting curved surface 331 at least comprises a focus. In the present embodiment, the reflecting curved surface 331 is an oval curved surface with a high reflection rate. However, in another embodiment, the reflecting curved surface 331 is a parabolic curved surface with a high reflection rate, provided that the reflecting curved surface 331 satisfies the following curve equation:

$$z = \frac{{cy}^{2}}{1 + \sqrt{1 - ( 1 + k ) {c}^{2} {y}^{2}}} + {α}_{1} {y}^{2} + {α}_{2} {y}^{4} + {α}_{3} {y}^{6} + {α}_{4} {y}^{8} + {α}_{5} {y}^{10} + {α}_{6} {y}^{12} + {α}_{7} {y}^{14} ,$$

wherein k is a conic constant, c is a curvature, and α₁ to α₇ are seven non-spherical constants. When, k is equal to −1, the reflecting curved surface is a parabolic curved surface with a high reflection rate.

The reflecting curved surface 331 is formed on an inner surface of the optical element 33. In the present embodiment, the reflecting curved surface 331 is consisted of a metal coating formed on the inner surface of the optical element 33 by electroplating or evaporation. Alternatively, in another preferred embodiment, the reflecting curved surface 331 is consisted of a multi-layered dielectric coating formed on the inner surface of the optical element 33 by electroplating or evaporation.

The light-emitting diode 31 is located at a focus of the reflecting curved surface 331 of the optical element 33, such that light beams can be emitted onto the reflecting curved surface 331 and guided in a specific direction. As the light-emitting diode 31 is located at the focus of the reflecting curved surface 331 of the optical element 33, the light beam generated by the light-emitting diode 31 can be prevented from being again interlaced after being reflect-coupled by the reflecting curved surface 331 of the optical element 33. Thus, the light beam is not shielded by the light-emitting diode 31 after being reflect-coupled, such that a loss in an output efficiency of light beams can be avoided to improve the output efficiency of light beams.

Referring to FIG. 4A, as the light-emitting diode 31 is located at the focus of the reflecting curved surface 331 of the optical element 33, the light beam generated by the light-emitting diode 31 is able to limit an output half angle of light beams within a small range after being reflect-coupled by the reflecting curved surface 331 of the optical element 33. The degree of the half angle is determined by the curvature of the reflecting curved surface 331 and the size of the light-emitting diode 31. Regarding to a general light-emitting diode 31 with the size of 1 mm×1 mm, a full width in half maximum (FWHM) is limited smaller than 8 degrees, such that the light collecting effect of the light-beam generator and the output efficiency of light beams can be remarkably improved.

Moreover, the light beam generated by the light-beam generator 3 proposed in the present invention is not shielded and the loss in the output efficiency of light beams can be avoided. Also, the allocation of the light-emitting diode 31 and the optical element 33 is specifically designed. Thus, the best output efficiency of light beams can be achieved. Therefore, the light beam can be guided in a specific direction and thus the present invention can be applied to a projecting system having illuminant with specific polarized directions, so as to meet the requirement for a liquid displaying element (such as a liquid crystal display, a liquid crystal on silicon and a digital micromirror device).

As the light beam generated by the light-beam generator 3 proposed in the present invention is not shielded, the light beam is not interlaced with the light-emitting diode 31. Thus, specific heat dissipation is not needed and a heat dissipation requirement can be reduced. Therefore, not only the dimension of the light-beam generator 3 can be reduced but also the projecting system can be miniaturized.

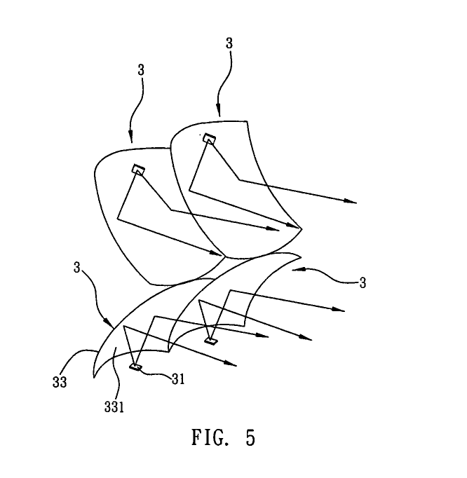

Referring to FIG. 4 and FIG. 5, the present invention also proposes a projecting system 4 comprising the foregoing light-beam generator. Referring to the figure, the projecting system 4 comprises a plurality of symmetric light-beam generators 3 arranged in arrays, a collimating illumination device 41 and an imaging device 43. What needs to be concerned is that in the present embodiment a plurality of symmetric light-beam generators 3 arranged in arrays serves to provide a description for the present invention, and can be easily understood by one skilled in the pertinent art. In other words, in another embodiment a single light-beam generator 3 can be provided, and thus the amount of the light-beam generator is not limited by the present embodiment.

The light-beam generator 3 is consistent with the foregoing embodiment and comprises an optical element 33 and a light-emitting diode 31. The optical element 33 comprises a non-spherical reflecting curved surface 331 which at least comprises a focus, and the light-emitting diode 31 is located at the focus of the optical element 33 for emitting light to the reflecting curved surface 331 to form a light beam which is guided in a specific direction. In the present embodiment, in order to maintain the characteristic of half-plane light emission for the light-emitting diode 31, the plurality of light-beam generators 3 are arranged symmetrically and in arrays. Thus, a maximum number of light-emitting diodes 31 can be provided in a minimum area, so as to further thin and miniaturize the projecting system 4. Additionally, in the present embodiment, the reflecting curved surface 331 is a parabolic curved surface with a high reflection rate. Also, the light-emitting diode 31 of each of the light-beam generators 3 can be a combination of at least two light-emitting diodes selected from the group consisting of red light, blue light, green light and white light.

The collimating illumination device 41 serves to receive the light beam generated by the light-beam generator 3 and subsequently uniformize the light beam and increase efficiency of the light beam. The collimating illumination device is an array-arranged lens in the present embodiment, or alternatively, can be an optical tunnel in another embodiment.

The imaging device 43 serves to receive the light beam from the collimating illumination device 41 and adjust an image picture into the light beam to form an image light beam for projection. In the present embodiment, the imaging device 43 comprises a displaying element 431 such as a liquid crystal display (LCD) and a projecting lens 433. In other embodiments, the displaying element 431 can be a liquid crystal on silicon (LCOS) or a digital micromirror device (DMD). As the imaging device 43 and the foregoing collimating illumination device 41 are not the main technical features of the present invention and can be easily understood and replaced by one skilled in the pertinent art, the effects and allocation will not be further described.

Referring to the light-beam generator and the projecting system having the light-beam generator proposed in the present invention, the specific allocation relationship between the light-emitting diode of the light-beam generator and the optical element and the design of the reflecting curved surface of the optical element are able to prevent the light beams generated by the light-emitting diode from being again interlaced after being reflect-coupled by the optical element. Thus, in comparison to the prior-art, the light beam is not shielded by the light-emitting diode after being reflect-coupled, such that a loss in an output efficiency of light beams can be avoided to improve the output efficiency of light beams and reduce a heat dissipation requirement. Therefore, the dimension of the light-beam generator can be reduced and the projecting system can also be miniaturized. As the light beam generated by the light-beam generator proposed in the present invention is not shielded and the loss in the output efficiency of light beams can be avoided, the best output efficiency of light beams can be achieved. By such arrangement, the light beam can be guided in a specific direction and thus the present invention can be applied to a projecting system having illuminant with specific polarized directions, so as to meet the requirement for the liquid displaying element (such as a liquid crystal display, a liquid crystal on silicon and a digital micromirror device). Accordingly, the light-beam generator and the projecting system having the light-beam generator proposed in the present invention are able to eliminate the prior-art drawbacks.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A light-beam generator comprising:
an optical element having a non-spherical reflecting curved surface comprising a focus; and
a light-emitting diode located at the focus for emitting light to the non-spherical reflecting curved surface to form a light beam which is guided in a specific direction.

2. The light-beam generator of claim 1, wherein the non-spherical reflecting curved surface is a parabolic curved surface with a high reflection rate.

3. The light-beam generator of claim 1, wherein the non-spherical reflecting curved surface is an oval curved surface with a high reflection rate.

4. The light-beam generator of claim 1, wherein the non-spherical reflecting curved surface is consisted of a metal coating formed on a surface of the optical element.

5. The light-beam generator of claim 1, wherein the reflecting curved surface is consisted of a dielectric coating formed on a surface of the optical element.

6. The light-beam generator of claim 1, wherein the reflecting curved surface meets the following equation:
$$z = \frac{{cy}^{2}}{1 + \sqrt{1 - ( 1 + k ) {c}^{2} {y}^{2}}} + {α}_{1} {y}^{2} + {α}_{2} {y}^{4} + {α}_{3} {y}^{6} + {α}_{4} {y}^{8} + {α}_{5} {y}^{10} + {α}_{6} {y}^{12} + {α}_{7} {y}^{14} ,$$
wherein k is a conic constant, c is a curvature, and α₁ to a₇ are seven non-spherical constants.

7. The light-beam generator of claim 1, wherein the light-emitting diode is a light-emitting diode which emits light selected from the group consisting of red light, blue light, green light and white light.

8. The light-beam generator of claim 1, wherein the light-emitting diode is in the form of a bare chip or a package.

9. A projecting system comprising:
a light-beam generator comprising an optical element and a light-emitting diode, the optical element comprising a non-spherical reflecting curved surface comprising a focus, the light-emitting diode being located at the focus for emitting light to the non-spherical reflecting curved surface to form a light beam which is guided in a specific direction;
a collimating illumination device for receiving the light beam from the light-beam generator and subsequently uniformizing the light beam and increasing efficiency of the light beam; and
an imaging device for receiving the light beam from the collimating illumination device and adjusting an image picture into the light beam to form an image light beam for projection.

10. The projecting system of claim 9, wherein the collimating illumination device is selected from an array-arranged lens or an optical tunnel.

11. The projecting system of claim 9, wherein the imaging device comprises a displaying element and a projecting lens.

12. The projecting system of claim 11, wherein the displaying element can be selected from the group consisting of a liquid crystal display (LCD), a liquid crystal on silicon (LCOS) and a digital micromirror device (DMD).

13. The projecting system of claim 9, wherein the reflecting curved surface is a parabolic curved surface with a high reflection rate.

14. The projecting system of claim 9, wherein the reflecting curved surface is an oval curved surface with a high reflection rate.

15. The projecting system of claim 9, wherein the reflecting curved surface is consisted of a metal coating formed on a surface of the optical element.

16. The projecting system of claim 9, wherein the reflecting curved surface is consisted of a dielectric coating formed on a surface of the optical element.

17. The projecting system of claim 9, wherein the reflecting curved surface meets the following equation:
$$z = \frac{{cy}^{2}}{1 + \sqrt{1 - ( 1 + k ) {c}^{2} {y}^{2}}} + {α}_{1} {y}^{2} + {α}_{2} {y}^{4} + {α}_{3} {y}^{6} + {α}_{4} {y}^{8} + {α}_{5} {y}^{10} + {α}_{6} {y}^{12} + {α}_{7} {y}^{14} ,$$
wherein k is a conic constant, c is a curvature, and α₁ to α₇ are seven non-spherical constants.

18. The projecting system of claim 9, wherein the light-emitting diode of the light-beam generator is a combination of at least two selected from the group consisting of a red light LED, a blue light LED, a green light LED and a white light LED.

19. The projecting system of claim 9, wherein the light-emitting diode is in the form of one selected from a bare chip or a package.

20. The projecting system of claim 9, further comprising a plurality of symmetric light-beam generators arranged in arrays.
